(19) United States
(12) Patent Application Publication
(10) Pub. No.: US 2008/0036729 A1
(43) Pub. Date: Feb. 14, 2008

(54) Backlight control method, backlight control system and liquid crystal display device

(76) Inventor: Yoji Mukuda, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/826,708

(22) Filed: Jul. 18, 2007

(30) Foreign Application Priority Data
Aug. 1, 2006 (JP) 2006-209563

(51) Int. Cl. G09G 3/36

(52) U.S. Cl. 345/102

(57) ABSTRACT

A backlight signal used for luminance control of a backlight and a RGB signal to be transmitted to a liquid crystal display panel side are extracted based on encoded data of received image information (image data). Then, the backlight signal is transmitted to the backlight and the RGB signal to the liquid crystal display panel, while the remaining data is discarded. The backlight signal used for luminance control of an image is extracted from decoded image information.

### BACKGROUND OF THE INVENTION

1. Field of the Invention

The present invention relates to a technique associated with liquid crystal display devices, and more specifically, to a technique for controlling backlight used in liquid crystal display panels.

2. Description of the Related Art

The non-self-luminous nature of liquid crystals in liquid crystal displays requires that such a display is externally lighted by irradiating light using a backlight. Although there are backlights that use fluorescent lamps (cold cathode tubes), light-emitting diodes (LEDs) or electroluminescence (EL) as light sources, conventionally, backlights that use fluorescent lamps as light sources have been the mainstream.

However, since lighting a fluorescent lamp requires that a high voltage (around 700 V) with a frequency in the order of several tens kHz is applied to both ends of the lamp, there is a problem in that current leakage via minute floating capacitance, disconnection, short-circuit and the like are likely to occur. In addition, due to the bluish tinge of white light produced by a fluorescent lamp, the whiteness thereof makes it insufficient for achieving high color reproducibility. Furthermore, the use of mercury, which is an environmental toxin, in fluorescent lamps to facilitate in-tube discharge is not preferable from the perspective of environmental protection.

On the other hand, using LEDs as light sources for a backlight has advantages such as: a long operating life, resistance to shock, and a less likelihood of short-circuiting; superior chromatic purity; being a low-voltage operating element, superior handling and safety, and easy to downsize; a low level of temporal variations in luminance; and excellent linearity of luminescent quantity with respect to current value, and high response speed. Accordingly, research and development on LED backlights have been underway.

For instance, Japanese Patent No. 3584351 discloses an invention that enables a liquid crystal display device provided with LEDs as a backlight to split the luminous region of the backlight and control the luminescence intensity of each luminous region according to the optical transmittance of the liquid crystal panel in order to suppress luminance heterogeneity in display areas and, at the same time, to selectively increase luminance in a specific display area in comparison to other display areas without significantly increasing power consumption.

In addition, Japanese Patent No. 3738427 discloses an invention that is arranged to solve the problem of a rapid decline in the responsiveness of a liquid crystal panel due to a decline in liquid crystal temperature by utilizing the limiting resistor of a LED that is used as a backlight to heat liquid crystals in order to provide temperature compensation for the responsiveness of the liquid crystals.

Information of a color image is projected on a device that converts light passed through filters of the three primary colors—red (R), green (G) and blue (B)—into an electric signal. Outputs from the device are used as signals (RGB signals) respectively corresponding to the luminescence intensities of R, G, and B to form an image signal.

FIGS. 1A to 1D are diagrams for explaining conventional and typical image information processing. Image information (image data) is encoded and transmitted (FIG. 1A), and then decoded (FIG. 1B). An RGB signal is extracted from the decoded data (FIG. 1C), and the RGB signal is transmitted to the display panel while remaining data is discarded (FIG. 1D).

The RGB signal holds, for instance, 24 bits (8 bits of each of RGB) of information. Sending this information to a liquid crystal panel enables display of 2 to the 24th power (approximately 16.7 million) colors and 2 to the 8th power (256) tonal levels per pixel.

However, the dynamic range of a human eye is said to be several million-fold, which may be expressed in bits as a value exceeding 20 bits. In other words, for the human eye, mere 256 tones is nowhere near a sufficient tonal level and is inadequate for displaying images in high resolution and sufficient texture. In this light, HDMI (High Definition Multimedia Interface), which is a multimedia interface for digital signals, has expanded the information quantity of each of RGB to 14 bits (total of 42 bits).

With digital broadcasting for television, moving image data in MPEG2 data format is compressed and transmitted as information. Ground-based digital broadcasting and satellite digital broadcasting are similarly subject to high-efficiency encoding and transmission in MPEG2 data format. In MPEG, in addition to motion retrieval in the case of progressive scanning (non-interlace scanning), three motion retrieval methods in the case of interlace scanning (or interlaced scanning) are defined. For so-called Hi-Vision (HD) high-definition television screens, screen standards such as 720P (1280×720 pixels), 1080I (1920×1080 pixels) and 1080P (1920×1080 pixels) have been defined.

For playback of moving images, received encoded signals in MPEG2 data format must be decoded and processing for generating image/audio information must be performed. Primarily, since this processing is primarily continuous processing of product-sums using a predetermined coefficient and the information that results from computation is average information of a sampling period, information quantity may easily be expanded. Thus, it would be easy to acquire information corresponding to the mere 14 bits per RGB (total 42 bits) that is processed by HDMI.

The quantity of information obtained by decoding MPEG2-format encoded signals is intrinsically high. RGB signals used in image display in ordinary liquid crystal display devices are set to 8 bits of each of RGB (total 24 bits). This is because the limitations imposed on information processing at the display device-side causes only the high 8 bits of image information respectively corresponding to RGB to be extracted and used as RGB information while the remaining information is discarded.

In other words, while image information obtained through composition intrinsically contains enough information to enable display of color images with an extremely large number of tones, conventional image display methods only use a portion (in the above example, 8 bits of the luminance signal) of the intrinsic image information. Thus, it is inevitable that the number of tonal levels displayable on a liquid crystal display panel is limited.

### SUMMARY OF THE INVENTION

The present invention has been made in consideration of the above problems, and its object is to enhance the tones of images displayed on a liquid crystal display panel by controlling the emitting state of LEDs used as a backlight based on image information inputted to the liquid crystal display device.

In order to solve such problems, a backlight control method for a liquid crystal display device according to the present invention comprises: a first step for decoding RGB information of respectively K bits of RGB based on encoded image information corresponding to a single screen; a second step for extracting color information of maximum luminance from the RGB information; and a third step for determining a backlight signal to be associated with the luminance of a backlight comprising of LEDs based on predetermined B bits of data including the most significant bit among bit data of color information with maximum luminance, wherein the third step comprises: a first substep for determining whether the maximum luminance is within a luminance control range of the backlight based on the B bits of data and when determined that the maximum luminance is within the luminance control range, controls the luminance of the backlight based on the B bits of data; and a second substep for generating a backlight signal that sets the backlight to minimum luminance when it is determined that the maximum luminance is lower than the luminance control range.

The backlight control method preferably comprises a fourth step for determining an RGB signal, and is arranged so that, when the first substep is executed, L bits of data including at least 1 bit of the B bits of data is generated as the RGB signal, while on the other hand, L bits of data from the most significant bit to a bit in the range of the (B+1)st order bit to the (B+L)st order bit of RGB information of K bits of each of RGB is generated as the RGB signal following the execution of the second substep.

In another aspect of a backlight control method for a liquid crystal display device according to the present invention, the method comprises: a first step for decoding RGB information of respectively K bits of RGB based on encoded image information corresponding to a single screen; a second step for respectively extracting maximum luminance from each of the RGB information; and a third step for determining a backlight signal to be associated with the luminance of a backlight comprising of a red series LED, a green series LED and a blue series LED based on predetermined B bits of data including the most significant bit among bit data of the maximum luminance of each of the RGB information, wherein the third step comprises: a first substep for determining whether the respective RGB maximum luminances are within a luminance control range of the red series LED, the green series LED, and the blue series LED based on the B bits of data, and when determined that the maximum luminance is within the luminance control range, controls the luminance of the LED of the corresponding color based on the B bits of data; and a second substep for generating a backlight signal that sets the LED of the corresponding color to minimum luminance when it is determined that the maximum luminance is lower than the luminance control range.

The backlight control method preferably comprises a fourth step for determining an RGB signal, and is arranged so that, when the first substep is executed, L bits of data including at least 1 bit of the B bits of data is generated as the RGB signal of the corresponding color, while, on the other hand, L bits of data from the most significant bit to a bit in the range of the (B+1)st order bit to the (B+L)st order bit of RGB information of K bits of each of RGB is generated as the RGB signal of the corresponding color following the execution of the second substep.

A backlight control system for a liquid crystal display device according to the present invention comprises: an image information decoding unit that decodes RGB information of respectively K bits of RGB based on encoded image information corresponding to a single screen; an image luminance peak detecting unit that extracts color information of maximum luminance from the RGB information; and an image signal extraction unit that determines a backlight signal to be associated with the luminance of a backlight comprising of LEDs based on predetermined B bits of data including the most significant bit among bit data of color information with maximum luminance, wherein the image signal extraction unit comprises: computing means that determines whether the maximum luminance is within a luminance control range of the backlight based on the B bits of data, and when it is determined that the maximum luminance is within the luminance control range, controls the luminance of the backlight based on the B bits of data, while on the other hand, generates a backlight signal that sets the backlight to minimum luminance when it is determined that the maximum luminance is lower than the luminance control range.

The backlight control system is preferably arranged so that: the computing means provided in the image signal extraction unit generates L bits of data including at least 1 bit of the B bits of data as the RGB signal when it is determined that the maximum luminance is within the luminance control range of the backlight, while on the other hand, the computing means generates L bits of data from the most significant bit to a bit in the range of the (B+1)st order bit to the (B+L)st order bit of RGB information of K bits of each of RGB as the RGB signal when it is determined that the maximum luminance is lower than the luminance control range.

In another aspect of a backlight control system for a liquid crystal display device based on the present invention, the system comprises: an image information decoding unit that decodes decoding RGB information of respectively K bits of RGB based on encoded image information corresponding to a single screen; an image luminance peak detecting unit that respectively extracts maximum luminance from each of the RGB information; and an image signal extraction unit that determines a backlight signal to be associated with the luminance of a backlight comprising of a red series LED, a green series LED and a blue series LED based on predetermined B bits of data including the most significant bit among bit data of respective maximum luminances of each of the RGB information, wherein the image signal extraction unit comprises computing means that determines whether the respective RGB maximum luminances are within a luminance control range of the red series LED, the green series LED and the blue series LED based on the B bits of data, and when determined that the maximum luminance is within the luminance control range, controls the luminance of the LED of the corresponding color based on the B bits of data, while when it is determined that the maximum luminance is lower than the luminance control range, generates a backlight signal that sets the LED with the corresponding color to minimum luminance.

The backlight control system is preferably arranged so that: the computing means provided in the image signal extraction unit generates L bits of data including at least 1 bit of the B bits of data as the RGB signal of the corresponding color when it is determined that the maximum luminance is within the luminance control range of the backlight, while on the other hand, the computing means generates L bits of data from the most significant bit to a bit in the range of the (B+1)st order bit to the (B+L)st order bit of RGB information of K bits of each of RGB as the RGB signal of the corresponding color when it is determined that the maximum luminance is lower than the luminance control range.

In addition, the backlight control system according to the present invention may be arranged so as to comprise a backlight signal processing unit to which a backlight signal from the image signal extraction unit is inputted, wherein the backlight signal processing unit has an external interface for backlight luminance adjustment from the outside.

A liquid crystal display device according to the present invention comprises the backlight control system according to the present invention, and the lighting states of LEDs provided as a backlight are controlled by the above-described backlight control system.

As seen, according to the present invention, by arranging the lighting states of LEDs provided as a backlight to be controlled based on image information inputted to a liquid crystal display device, tone enhancement of images displayed on a liquid crystal display panel may be achieved. As a result, a liquid crystal display panel having a low tonal level may be used as a liquid crystal display panel having a high tonal level.

Furthermore, since this method merely causes tone control to be also performed at the backlight (LEDs) side based on information intrinsically included in image information, the method is extremely simple in principle and will not impede any demands for lightening, thinning or the like of the device.

Moreover, even when a user of the liquid crystal display device adjusts the brightness of an image through manual control, tone control of the image may be performed by controlling the light quantity of the backlight-side lighting without having to input the manual control as a signal to the liquid crystal panel-side.

### BRIEF DESCRIPTION OF THE DRAWINGS

Other objects, features and advantages of the present invention will become more apparent from the following detail description when read in conjunction with the accompanying drawings in which:

FIGS. 1A to 1D are diagrams for explaining processes of conventional image information processing;

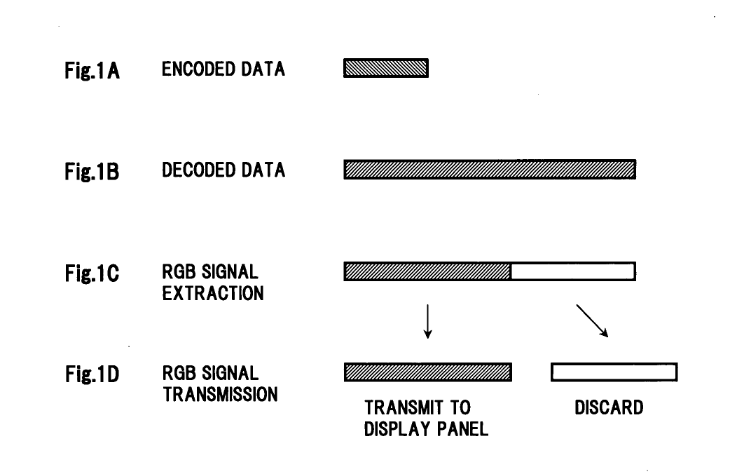

FIGS. 2A to 2D are diagrams for conceptually explaining processes of image information processing according to the present invention;

FIG. 3 is a diagram for explaining the principle of tone control according to the present invention;

FIG. 4 is a diagram for conceptually explaining the substantial tone enhancement that is achievable through tone control according to the present invention;

FIGS. 5A to 5D are diagrams for specifically explaining examples of display signal processing for tone control according to the present invention;

FIG. 6 is a block diagram for explaining a configuration example of an image signal generating unit for executing image information processing according to the present invention;

FIG. 7 is a block diagram for explaining a configuration example of a backlight signal processing unit that processes backlight signals;

FIG. 8 is a flowchart for explaining a first example of a procedure of tone control according to the present invention;

FIGS. 9A to 9E form a first diagram for specifically explaining the processing depicted in FIG. 8;

FIGS. 10A to 10E form a second diagram for specifically explaining the processing depicted in FIG. 8;

FIG. 11 is a flowchart for explaining a second example of a procedure of tone control according to the present invention; and

FIG. 12 is a diagram for explaining an outline of a configuration of a liquid crystal display device according to the present invention.

### DESCRIPTION OF THE PREFERRED EMBODIMENTS

Embodiments of the present invention will now be described with reference to the drawings. In the following description, while it is assumed that LEDs of three colors, namely, a red (R) LED, a green (G) LED and a blue (B) LED are used to obtain a white backlight, emission colors of these LEDs need not be limited to the three colors of red (R), green (G) and blue (B). For the backlighting LEDs used in the present invention, any backlighting LED may be used as long as a combination thereof is capable of producing white through color mixing. LEDs capable of forming such a combination shall be referred to as a red (R) series LED, a green (G) series LED and a blue (B) series LED.

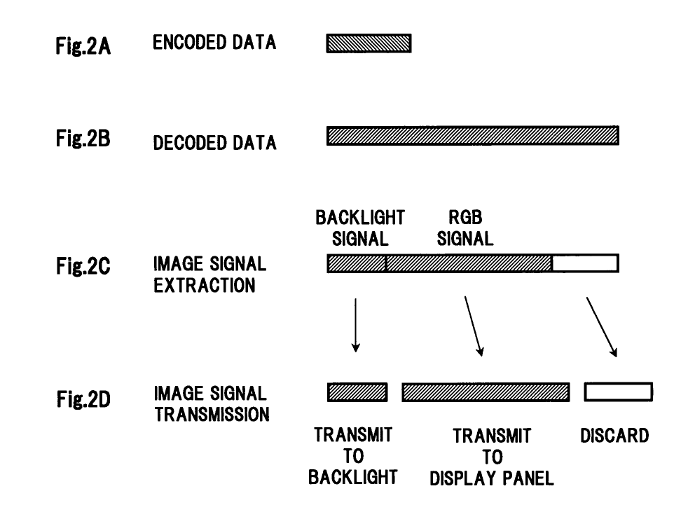

FIGS. 2A to 2D are diagrams for conceptually explaining exemplary processes of image information processing according to the present invention. Image information (image data) that has been encoded and transmitted is received (FIG. 2A), and decoded to obtain decoded data (FIG. 2B). Processing, to be described later, is performed on the decoded data to extract a backlight signal to be used in luminance control of the backlight and an RGB signal to be transmitted to the liquid crystal display panel-side (FIG. 2C). Then, the backlight signal is transmitted to the backlight and the RGB signal to the liquid crystal display panel, and the remaining data is discarded (FIG. 2D).

In other words, while in a conventional method, only RGB signals are considered image signals, in the present invention, in addition to RGB signals, backlight signals that control the luminance of the backlight are considered image signals. Accordingly, the respective luminances (tones) of the respective colors of red (R), green (G) and blue (B) are controlled from the liquid crystal display panel-side and the backlight side.

In the present invention, no special limitations are imposed on the number of bits of data extracted as the above-described backlight signal and RGB signals. When performing image display using a conventional liquid crystal display panel (and the control unit thereof), the number of bits for each of the RGB signals may be set to 8 bits to arrive at data with a total of 24 bits. In this case, tone control of 2 to the 8th power (256) tonal levels may be performed from the liquid crystal display-side.

In the present invention, since a backlight signal used for luminance control of images is extracted from decoded image information, tone control from the backlight side (tone control by the backlight signal) is performed in addition to the above-described tone control from the liquid crystal display panel-side (tone control by the RGB signals). As a result, tone enhancement of images displayed on the liquid crystal display panel may be achieved.

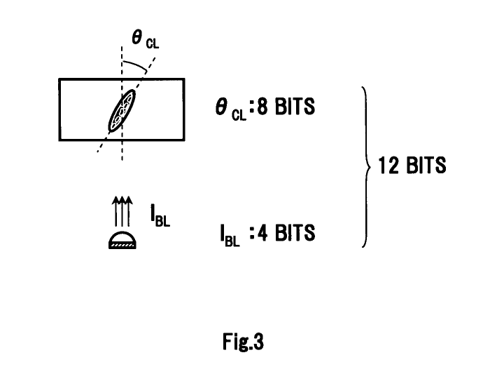

FIG. 3 is a diagram for explaining the principle of tone control according to the present invention. The example shown in this diagram assumes a case where, from the decoded image information, 4 bits of data are extracted as a backlight signal, and 8 bits of data are extracted as each of RGB signal (total of 24 bits). As described above, RGB signals (8 bits respectively) to be transmitted to the liquid crystal display panel-side are used for controlling voltage to be applied to liquid crystals corresponding to each color filter. Tone control of 8 bits (256) of levels is achieved by controlling the gradient states of the liquid crystal molecules.

In addition, a backlight signal having a data quantity of, for instance, 4 bits is transmitted to the backlight-side, and luminance control of the backlight is performed according to this signal. For instance, when using an LED (white) as a backlight, luminance control from the backlight-side is performed by controlling a current value that flows to the LED as a light source, and tone control of 4 bits (16) of levels is performed.

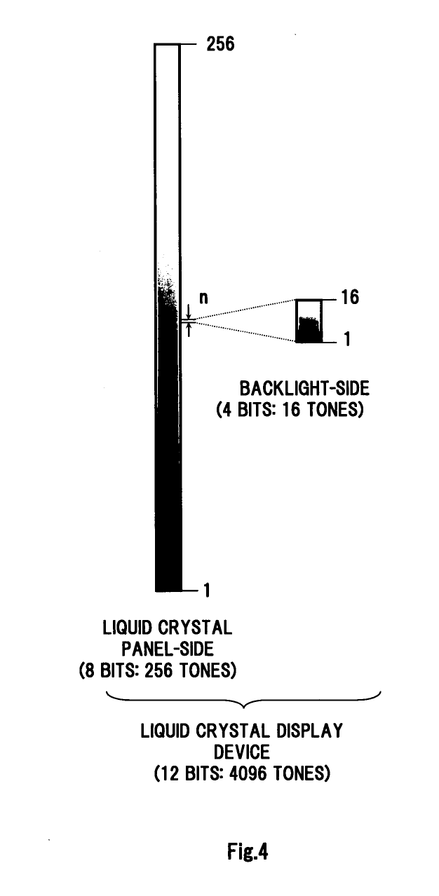

As shown in FIG. 4, according to tone control as described above, as a result of the 8-bit (256 tone) luminance control at the liquid crystal display panel-side and the 4-bit (16 tone) luminance control at the backlight-side, the liquid crystal display device as a whole is now capable of 12-bit (4096 tone) luminance control and may achieve significant tone enhancement.

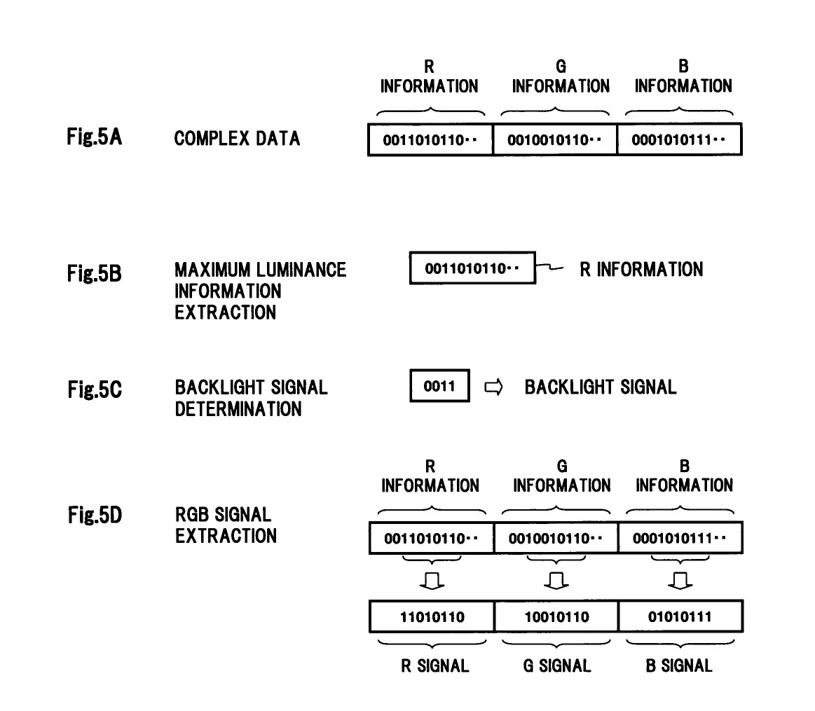

FIGS. 5A to 5D are diagrams for specifically explaining examples of display signal processing for tone control according to the present invention. Data resulting from decoding image information includes information regarding the brilliance of the three colors of red (R), green (G) and blue (B) of a single screen (respectively depicted as “R information”, “G information” and “B information”) (FIG. 5A). In this diagram, “R information” is represented as a digit sequence of “0011010110 . . . ”, “G information” as a digit sequence of “0010010110 . . . ” and “B information” as a digit sequence of “0001010111 . . . ”.

A comparison between the respective exemplified RGB information reveals that, in the “B information”, the values of the most significant bit to the third bit therefrom are “0” and the first “1” appears at the fourth bit (from the most significant bit), while in “R information” and “G information”, “1” initially appears at the third bit (from the most significant bit). In addition, a comparison of the fourth bits (from the most significant bits) of R information and G information, R information has a value of “1” while G information has a value of “0”. In this case, the color red (R) is determined to be the brightest color among the RGB information, and R information will be extracted as “maximum luminance information” (FIG. 5B).

A digit sequence of a predetermined number of bits (4 bits in the diagram) from the most significant bit of the digit sequence “0011010110 . . . ” of the “maximum brilliance information” is extracted and determined (generated) as a backlight signal “0011”. Luminance control of the backlight is performed based on the 4-bit backlight signal (FIG. 5C).

RGB signals are generated following the generation of the backlight signal, whereby tone control is performed at the liquid crystal display panel-side. As a specific example, among the digit sequence of R information of the maximum luminance information, the bit sequence from the most significant bit to the bit at which “1” initially appears (in the illustrated example, the most significant bit and the second order bit) is ignored, and a subsequent bit sequence from the high order bit thereof to a bit of a predetermined digit is extracted and defined as an R signal. In the illustrated example, since R signals are arranged to be 8 bits, the “0” of the most significant bit and the second order bit are ignored, and the subsequent 8-digit sequence “11010110” is extracted as the R signal (FIG. 5D).

A G signal and a B signal are extracted in the same manner. The first 8 digits “10010110” of the G information digit sequence when the most significant bit and the second order bit thereof are ignored is extracted as the G signal, and, similarly, the first 8 digits “01010111” of the B information digit sequence when the most significant bit and the second order bit thereof are ignored is extracted as the B signal (FIG. 5D).

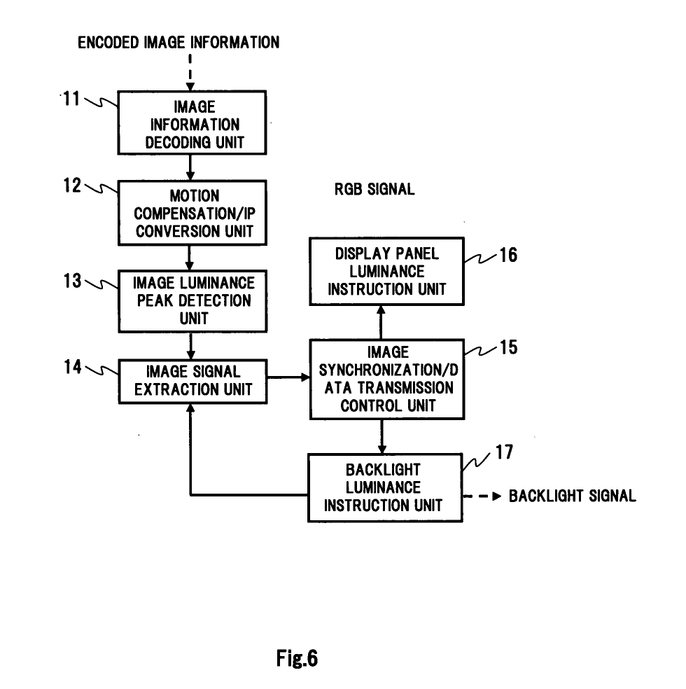

FIG. 6 is a block diagram for explaining a configuration example of an image signal generating unit for executing image information processing described above. When encoded image information is inputted, decoding is performed by an image information decoding unit (11). The decoded data is transmitted to, for instance, a motion compensation/IP conversion unit (12) at which motion compensation, IP conversion and the like is performed on the inputted image information, and subsequently transmitted to an image luminance peak detection unit (13).

In accordance with the procedure described with reference to FIGS. 5A to 5D, the image luminance peak detection unit (13) extracts maximum luminance information (information having the highest luminance among RGB information) from image information corresponding to a single screen. The image luminance peak detection unit (13) sends the decoded data to an image signal extraction unit (14). The image signal extraction unit (14) extracts a backlight signal and an RGB signal according to the procedure described with reference to FIGS. 5A to 5D, and sends these signals as image signals to an image synchronization/data transmission control unit (15).

The image synchronization/data transmission control unit (15) sends the RGB signal among the display signals to a display panel luminance instruction unit (16) and the backlight signal to a backlight luminance instruction unit (17). The RGB signal and the backlight signal are transmitted in synchronization to a display timing of the liquid crystal display panel.

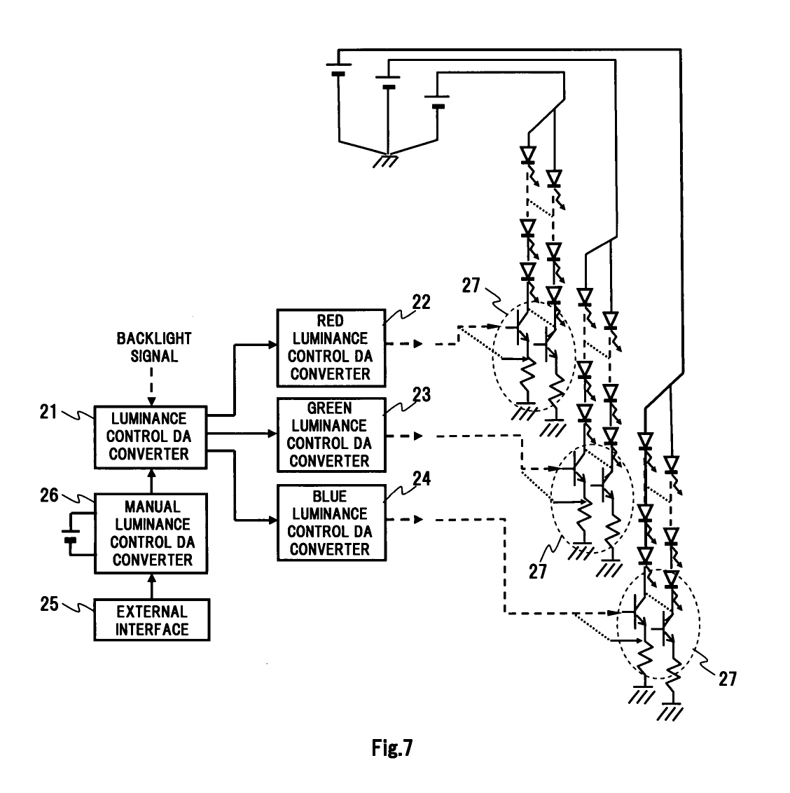

FIG. 7 is a block diagram for explaining a configuration example of a backlight signal processing unit that processes the above described backlight signal. The backlight signal outputted from the image signal generation unit is inputted to a luminance control DA converter 21, where luminance control signals for controlling the respective luminances of the backlighting LEDs of the three colors of red, green and blue which are required to set the luminance of the backlight light source (luminance of white light) to a predetermined value are transmitted to luminance control DA converters (22, 23 and 24) respectively corresponding to each of RGB.

Each of the luminance control DA converters (22, 23 and 24) performs analog conversion of the luminance control signal of each color. The analog-converted signals are sent to a current control circuit unit (27) to be converted into current values to be supplied to each LED. The luminance control DA converter (21) is arranged to accept manual input of luminance adjustment signals from the outside via an external interface (25) and a manual luminance control DA converter (26).

As seen, according to the present invention, as a result of the luminance control at the liquid crystal display panel-side and the luminance control at the backlight-side, the liquid crystal display device as a whole is now capable of achieving significant tone enhancement.

Embodiments of the present invention will now be described in greater detail using examples.

### EXAMPLE 1

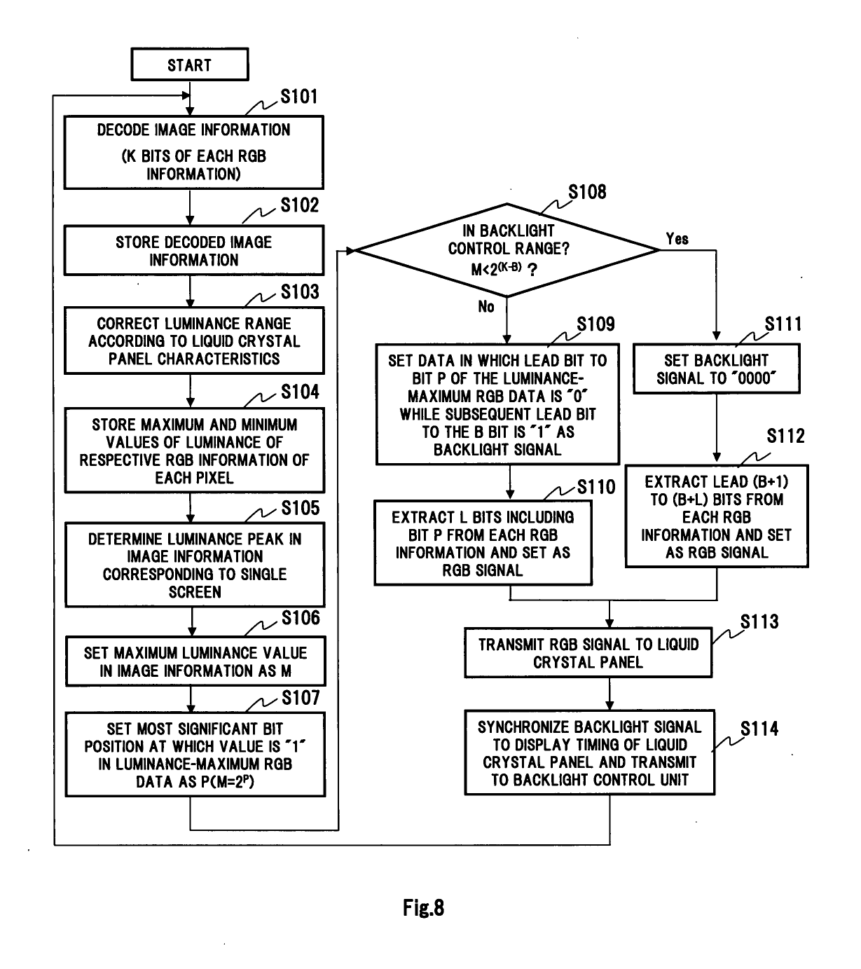

FIG. 8 is a flowchart for explaining a first example of a procedure of tone control according to the present invention. First, the procedure commences when image information corresponding to a single screen is inputted, and decoding of the image information is performed (S101). For the illustrated example, it is assumed that each of the RGB information has an information quantity of K bits (total of 3K bits).

The decoded RGB information is stored (S102), and luminance range correction corresponding to the characteristic of the used liquid crystal display panel is performed (S103). This luminance range correction is, for instance, correction for allocating a fewer number of bits to tonal regions where luminance is high and low and the sensitivity of the human eye is relatively low, and allocating a greater number of bits to ranges of medium luminance where the sensitivity of the human eye is relatively high.

Next, for each of the RGB information corresponding to each pixel, the maximum value and the minimum value of the luminance are stored (S104), a highest luminance peak among the image information corresponding to a single screen is obtained (S105), and the maximum luminance thereof is defined as M (S106).

RGB data extracted as having the maximum luminance from the RGB information is processed, and the most significant bit position at which “1” appears is set as P. As a result of this processing, a relationship of M=2^{P} is obtained between the aforementioned M and P (S107).

Subsequently, determination is made on whether luminance control by the backlight is possible (S108). In this example, since the number of bits of the backlight signal is set as B bits, the above determination is performed as a comparison between the value of M (=2^{P}) and the value of 2^{(K-B)}.

When the value of M (=2^{P}) is not smaller than the value of 2^{(K-B)} (No in S108), the procedure proceeds to step S109 where data in which the lead (most significant) bit to the aforementioned P bit of the luminance-maximum RGB data is set to “0” while the subsequent lead bit to the B bit is set to “1” is formed as the backlight signal. Then, L bits including bit P are extracted from each RGB information and set as the RGB signal (S110).

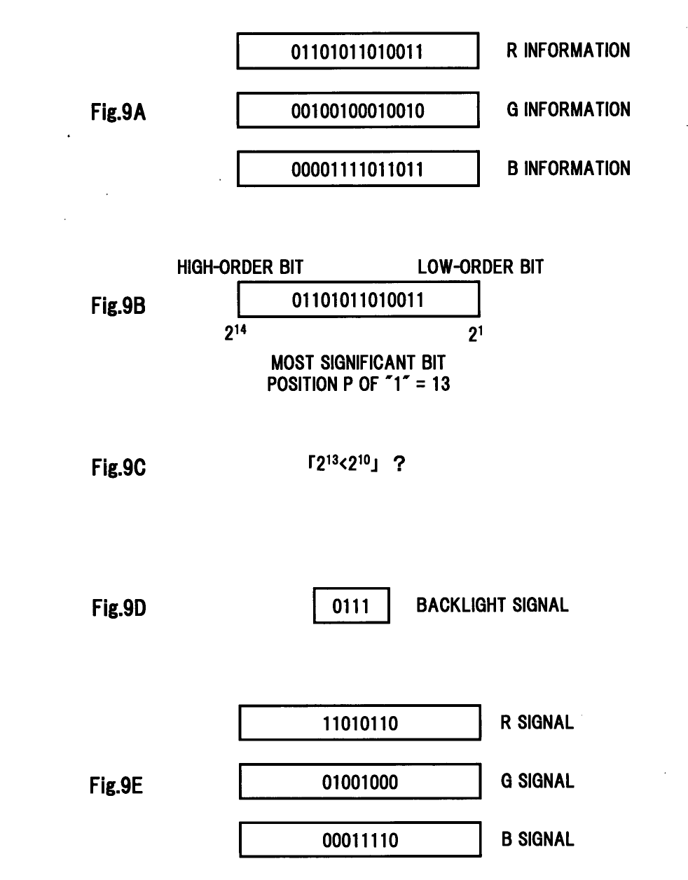

FIG. 9A to 9E are diagrams for describing the above processing in greater detail. In this case, for easier comprehension, each RGB information is assumed to be 14 bits (K=14), the number of bits of backlight signals to be 4 bits (B=4) and the number of each of RGB signal to be 8 bits (L=8).

For instance, if “01101011010011” is inputted as R information, “00100100010010” as G information and “00001111011011” as B information (FIG. 9A), since R information has the maximum luminance among these RGB information, R information is selected (FIG. 9B).

With the R information “01101011010011”, since the most significant bit position of “1” is 13, P=13 is true. Thus, the determination criterion of step S108 shown in FIG. 8 (2^{P}<2^{(K-B)}?) may now be specifically expressed as “2¹³<2¹⁰?” (FIG. 9C).

In this case, since the determination will result in “No”, the procedure proceeds to step S109 where data in which the most significant bit subsequent to the P bit position (13 bit position) to the 4th bit of the R information “01101011010011” (in other words, the 4 bits at the positions of the 13 bit, 12 bit, 11 bit and the 10 bit) is set to “1” (“0111”) is created as the backlight signal (FIG. 9D). Performing such processing may possibly result in backlight signals of “0001”, “0011”, “0111” and “1111”. A signal of “0000” is generated by the processing of step S111, to be described later, as a signal corresponding to the minimum luminance of the backlight.

In an alternative arrangement, data formed by the most significant bit to the 4th bit of the R information “01101011010011” (“0110”) may be set without modification as the backlight signal. In this case, 4 bits (16) of backlights are conceivable.

Subsequent to this processing, L bits (8 bits) beginning at bit P (bit 13) are extracted from each RGB information as RGB signals (FIG. 9E).

In step S108, when the value of M (=2^{P}) is smaller than the value of 2^{(K-B)} (Yes in S108), the procedure proceeds to step S111 where the backlight signal is set to a predetermined constant (in this example “0000”), and L bits of data from the most significant bit to a bit in the range of the (B+1)st to the (B+L)th bit of each RGB information is extracted as RGB signals (S112).

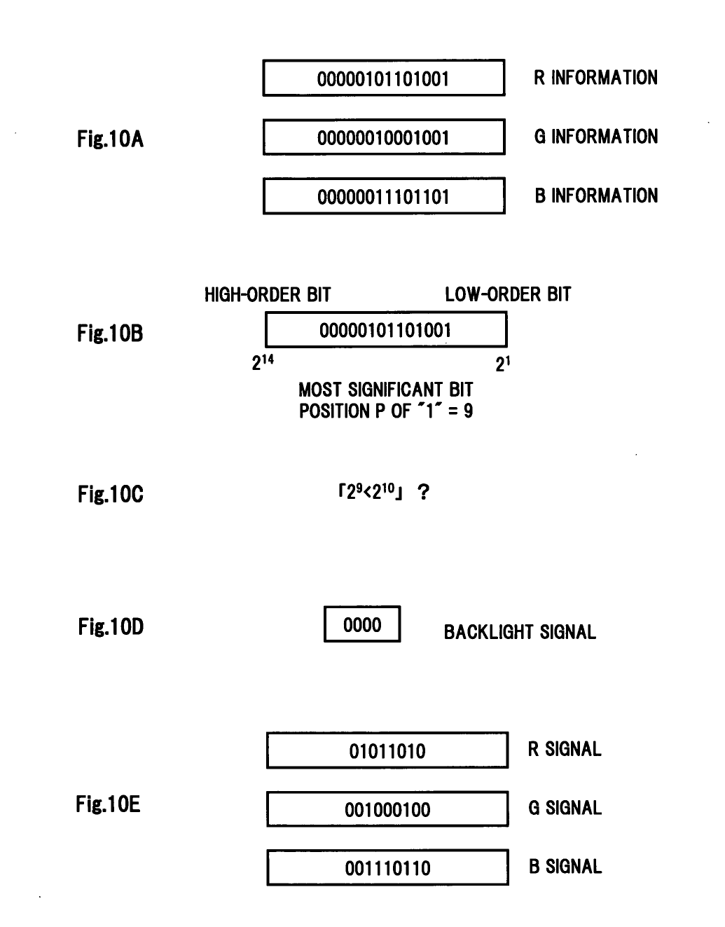

FIG. 10A to 10E are diagrams for describing the above processing in greater detail. In a similar manner, for easier comprehension, each RGB information is assumed to be 14 bits (K=14), the number of bits of a backlight signal to be 4 bits (B=4) and the number of each of RGB signals to be 8 bits (L=8).

For instance, if “00000101101001” is inputted as R information, “00000010001001” as G information and “00000011101101” as B information (FIG. 10A), since R information has the maximum luminance among these RGB information, R information is selected (FIG. 10B).

With the R information “00000101101001”, since the most significant bit position of “1” is 9, P=9 is true. Thus, the determination criterion of step S108 shown in FIG. 8 (2^{P}<2^{(K-B)}?) may now be specifically expressed as “2⁹<2¹⁰?” (FIG. 10C).

Since the determination result in this case is “Yes”, the procedure proceeds to step S111 to set the constant “0000” as the backlight signal (FIG. 10D). This backlight signal is a signal corresponding to the minimum luminance of the backlight.

Subsequent to this processing, ignoring the 4 bits beginning at the most significant bit of each RGB information, L bits (8 bits) beginning at bit 10 are extracted as RGB signals (FIG. 10E).

Through such processing, the obtained RGB signal is transmitted to the liquid crystal display panel (S113), while the backlight signal is synchronized to the display timing of the liquid crystal panel and transmitted to the lighting control unit of the backlight (S114).

The processing of the above-described steps S101 to S114 is performed for every screen to achieve moving image display.

### EXAMPLE 2

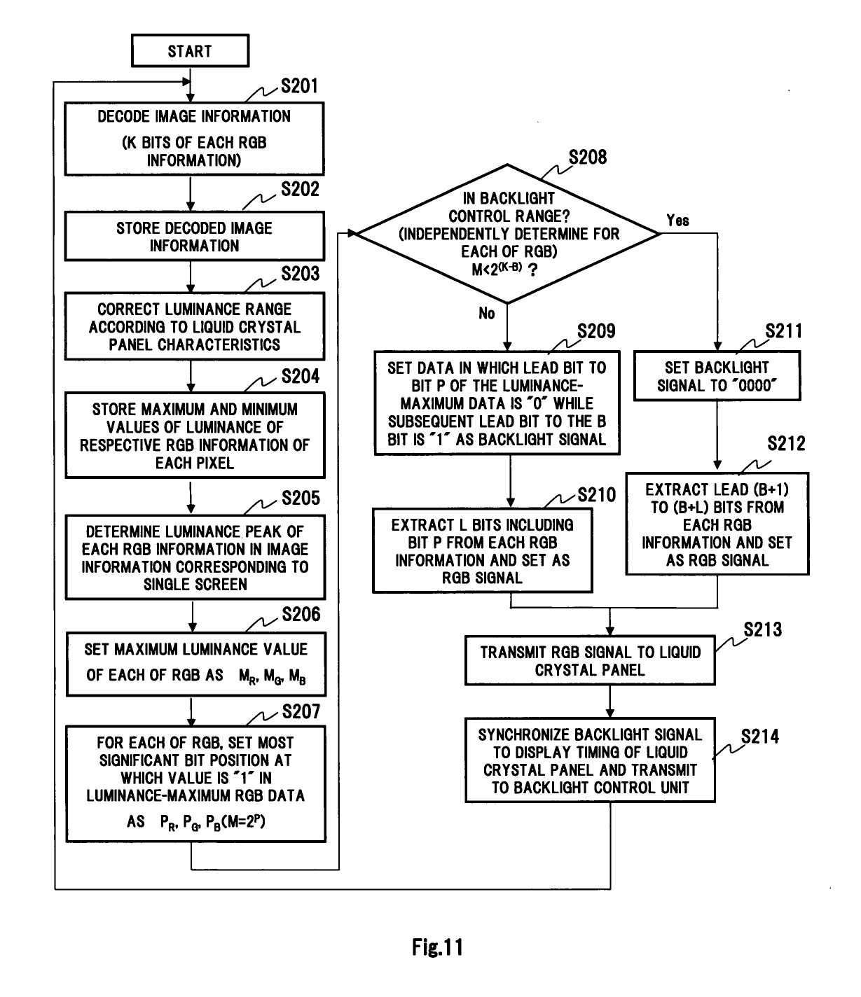

FIG. 11 is a flowchart for explaining a second example of a procedure of tone control according to the present invention. First, the procedure commences when image information corresponding to a single screen is inputted, and decoding of the image information is performed (S201). For the illustrated example as well, it is assumed that each RGB information has an information quantity of K bits (total of 3K bits).

The decoded RGB information is stored (S202), and luminance range correction corresponding to the characteristic of the used liquid crystal display panel is performed (S203). The contents of this luminance range correction is the same as already described for Example 1.

Next, for each RGB information corresponding to each pixel, the maximum value and the minimum value of the luminance are stored (S204), the luminance peak of each RGB information among image information corresponding to a single screen is obtained (S205), and for each color, the maximum luminance thereof is defined as M (M_{R}, M_{G}, M_{B}) (S206).

Maximum luminance data of each RGB information is processed, and for each color, the most significant bit position at which “1” appears is set as P (P_{R}, P_{G}, P_{B}). As a result of this processing, a relationship of M=2^{P} is obtained between the aforementioned M and P (S207).

Subsequently, determination is made on whether luminance control by backlight is possible (S208). In this example, since the number of bits of the backlight signal is set as B bits, the above determination is performed as a comparison between the value of M (=2^{P}) and 2^{(K-B)}. This determination is performed for each color of RGB.

When the value of M (=2^{P}) is not smaller than the value of 2^{(K-B)} (No in S208), the procedure proceeds to step S209 where data in which the lead (most significant) bit to the aforementioned P bit of the maximum luminance data is set to “0” while the subsequent lead bit to the B bit is set to “1” is formed as the backlight signal. Then, L bits including bit P are extracted from each RGB information and set as the R signal, the G signal and the B signal (S210).

In step S208, when the value of M (=2^{P}) is smaller than the value of 2^{(K-B)} (Yes in S208), the procedure proceeds to step S211 where the backlight signal is set to a predetermined constant (in this example “0000”), and respectively for R information, G information and B information, L bits of data from the most significant bit to a bit in the range of the (B+1)th to the (B+L)th bit are extracted as the R signal, G signal and B signal (S212).

Through such processing, the obtained RGB signals are transmitted to the liquid crystal display panel (S213), while the backlight signal is synchronized to the display timing of the liquid crystal panel and transmitted to the lighting control unit of the backlight (S214).

The processing of the above-described steps S201 to S214 is performed for every screen to achieve moving image display.

In the tone control of the first example, only the luminance of the white light obtained from the light of the LEDs of the three colors of red (R), green (G) and blue (B) is controlled, and luminance control of the LEDs of each color is not performed. Thus, white level (color tone) control of the backlight is not performed. In contrast, in the tone control of the second example, since luminance control is respectively performed for the LEDs of the three colors of red (R), green (G) and blue (B), it is now possible to perform color tone control of the backlight in addition to the luminance control of the white light.

### EXAMPLE 3

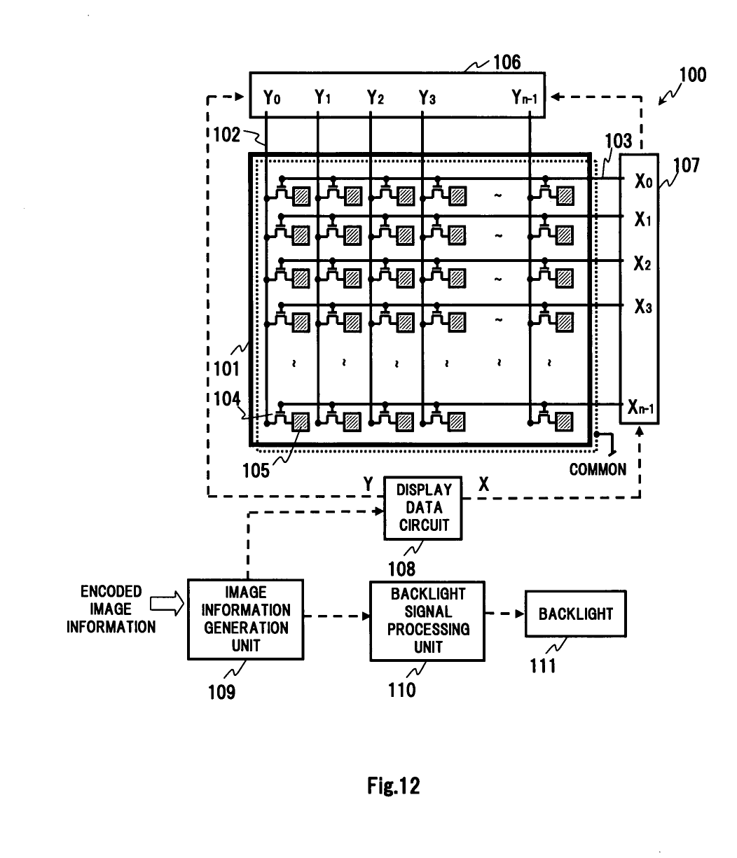

FIG. 12 is a diagram for explaining an outline of a configuration of a liquid crystal display device according to the present invention. In this liquid crystal display apparatus 100, a TFT 104 as a switching element and a storage capacitor (not shown) are positioned at each crossing position of data lines 102 and scan lines 103 configured in an n-row, n-column matrix on a substrate 101. The drain of the TFT 104 is connected to a pixel electrode 105, the source thereof to the data line 102, and a gate thereof to the scan line 103.

RGB signals from a display data circuit 108 is inputted to a data line drive circuit (gate line driver) 106 and a scan line drive circuit (scan line driver) 107, and is responsible for image display at the liquid crystal display panel-side.

RGB signals inputted to a display data circuit 108 are generated by an image information generation unit 109 based on encoded image information. A backlight signal generated by the image information generation unit 109 is sent to a backlight 111 via a backlight signal processing unit 110 to control intensity of emitting light of the LED, that is the light source.

While the present invention has been described through examples, the above-described examples are merely examples for implementing the present invention, and the present invention is not limited to these examples. Diverse variations of the above-described examples are within the scope of the present invention, and other various examples are further possible within the scope of the present invention. For instance, LEDs used as the backlight need not be LEDs of the three colors of red (R), green (G) and blue (B), and any backlighting LED may be used as long as a combination thereof is capable of producing a white LED through color mixing (a red (R) series LED, a green (G) series LED and a blue (B) series LED). Furthermore, a combination of a white LED and any of the aforementioned LEDs may be used.

Through the present invention, tone enhancement of images displayed on a liquid crystal display panel may be achieved. As a result, for instance, a liquid crystal display panel having a small number of tones may now be used as a liquid crystal display panel having a large number of tones.

What is claimed is:

1. A backlight control method for a liquid crystal display device comprising:
a first step for decoding RGB information of respectively K bits of RGB based on encoded image information corresponding to a single screen;
a second step for extracting color information of maximum luminance from the RGB information; and
a third step for determining a backlight signal to be associated with the luminance of a backlight comprising of LEDs based on predetermined B bits of data including the most significant bit among bit data of color information with maximum luminance, wherein
the third step comprises: a first substep for determining whether the maximum luminance is within a luminance control range of the backlight based on the B bits of data, and when determined that the maximum luminance is within the luminance control range, controls the luminance of the backlight based on the B bits of data; and a second substep for generating a backlight signal that sets the backlight to minimum luminance when it is determined that the maximum luminance is lower than the luminance control range.

2. The backlight control method for a liquid crystal display device according to claim 1, comprising:
a fourth step for determining an RGB signal, wherein
when the first substep is executed, L bits of data including at least 1 bit of the B bits of data is generated as the RGB signal, while on the other hand, L bits of data from the most significant bit to a bit in the range of the (B+1)st order bit to the (B+L)st order bit of RGB information of K bits of each of RGB is generated as the RGB signal following the execution of the second substep.

3. A backlight control method for a liquid crystal display device comprising:
a first step for decoding RGB information of respectively K bits of RGB based on encoded image information corresponding to a single screen;
a second step for extracting color information of maximum luminance from each of the RGB information; and
a third step for determining a backlight signal to be associated with the luminance of a backlight comprising of a red series LED, a green series LED and a blue series LED based on predetermined B bits of data including the most significant bit among bit data of the maximum luminance of each RGB information, wherein
the third step comprises: a first substep for determining whether the maximum luminances of RGB are within a luminance control range of the red series LED, the green series LED and the blue series LED based on the B bits of data and when determined that the maximum luminances are within the luminance control range of the red series LED, the green series LED and the blue series LED, controls the luminance of the LED of the corresponding color based on the B bits of data; and a second substep for generating a backlight signal that sets the LED of the corresponding color to minimum luminance when it is determined that the maximum luminance is lower than the luminance control range.

4. The backlight control method for a liquid crystal display device according to claim 3, comprising:
a fourth step for determining an RGB signal, wherein
when the first substep is executed, L bits of data including at least 1 bit of the B bits of data is generated as the RGB signal of a corresponding color, while on the other hand, L bits of data from the most significant bit to a bit in the range of the (B+1)st order bit to the (B+L)st order bit of RGB information of K bits of each of RGB is generated as the RGB signal of the corresponding color following the execution of the second substep.

5. A backlight control system for a liquid crystal display device, comprising:
an image information decoding unit that decodes RGB information of respectively K bits of RGB based on encoded image information corresponding to a single screen;
an image luminance peak detecting unit that extracts color information of maximum luminance from the RGB information; and
an image signal extraction unit that determines a backlight signal to be associated with the luminance of a backlight comprising of LEDs based on predetermined B bits of data including the most significant bit among bit data of color information with maximum luminance, wherein
the image signal extraction unit comprises: computing means that determines whether the maximum luminance is within a luminance control range of the backlight based on the B bits of data, and when it is determined that the maximum luminance is within the luminance control range, controls the luminance of the backlight based on the B bits of data, while, on the other hand, generates a backlight signal that sets the backlight to minimum luminance when it is determined that the maximum luminance is lower than the luminance control range.

6. A liquid crystal display device comprising a backlight consisting of LEDs and the backlight control system according to claim 5, wherein
the lighting states of the LEDs are controlled by the backlight control system.

7. The backlight control system for a liquid crystal display device according to claim 5, comprising:
a backlight signal processing unit to which a backlight signal from the image signal extraction unit is inputted, wherein
the backlight signal processing unit has an external interface for backlight luminance adjustment from the outside.

8. A liquid crystal display device comprising a backlight consisting of LEDs and the backlight control system according to claim 7, wherein
the lighting states of the LEDs are controlled by the backlight control system.

9. The backlight control system for a liquid crystal display device according to claim 5, wherein:
the computing means provided in the image signal extraction unit generates L bits of data including at least 1 bit of the B bits of data as the RGB signal when it is determined that the maximum luminance is within the luminance control range of the backlight, while on the other hand, the computing means generates L bits of data from the most significant bit to a bit in the range of the (B+1)st order bit to the (B+L)st order bit of RGB information of K bits of each of RGB as the RGB signal when it is determined that the maximum luminance is lower than the luminance control range.

10. A liquid crystal display device comprising a backlight consisting of LEDs and the backlight control system according to claim 9, wherein
the lighting states of the LEDs are controlled by the backlight control system.

11. The backlight control system for a liquid crystal display device according to claim 9, comprising:
a backlight signal processing unit to which a backlight signal from the image signal extraction unit is inputted, wherein
the backlight signal processing unit has an external interface for backlight luminance adjustment from the outside.

12. A liquid crystal display device comprising a backlight consisting of LEDs and the backlight control system according to claim 11, wherein
the lighting states of the LEDs are controlled by the backlight control system.

13. A backlight control system for a liquid crystal display device, comprising:
an image information decoding unit that decodes decoding RGB information of respectively K bits of RGB based on encoded image information corresponding to a single screen;
an image luminance peak detecting unit that respectively extracts maximum luminance from each of the RGB information; and
an image signal extraction unit that determines a backlight signal to be associated with the luminance of a backlight comprising of a red series LED, a green series LED and a blue series LED based on predetermined B bits of data including the most significant bit among bit data of respective maximum luminances of RGB information, wherein
the image signal extraction unit comprises computing means that determines whether the respective RGB maximum luminances are within a luminance control range of the red series LED, the green series LED and the blue series LED based on the B bits of data, and when determined that the maximum luminance is within the luminance control range, controls the luminance of the LED of the corresponding color based on the B bits of data, while when it is determined that the maximum luminance is lower than the luminance control range, generates a backlight signal that sets the LED with the corresponding color to minimum luminance.

14. A liquid crystal display device comprising a backlight consisting of LEDs and the backlight control system according to claim 13, wherein
the lighting states of the LEDs are controlled by the backlight control system.

15. The backlight control system for a liquid crystal display device according to claim 13, comprising:
a backlight signal processing unit to which a backlight signal from the image signal extraction unit is inputted, wherein
the backlight signal processing unit has an external interface for backlight luminance adjustment from the outside.

16. A liquid crystal display device comprising a backlight consisting of LEDs and the backlight control system according to claim 15, wherein
the lighting states of the LEDs are controlled by the backlight control system.

17. The backlight control system for a liquid crystal display device according to claim 13, wherein:
the computing means provided in the image signal extraction unit generates L bits of data including at least 1 bit of the B bits of data as the RGB signal of the corresponding color when it is determined that the maximum luminance is within the luminance control range of the backlight, while on the other hand, the computing means generates L bits of data from the most significant bit to a bit in the range of the (B+1)st order bit to the (B+L)st order bit of RGB information of K bits of each of RGB as the RGB signal of the corresponding color when it is determined that the maximum luminance is lower than the luminance control range.

18. A liquid crystal display device comprising a backlight consisting of LEDs and the backlight control system according to claim 17, wherein the lighting states of the LEDs are controlled by the backlight control system.

19. The backlight control system for a liquid crystal display device according to claim 17, comprising:
a backlight signal processing unit to which a backlight signal from the image signal extraction unit is inputted, wherein the backlight signal processing unit has an external interface for backlight luminance adjustment from the outside.

20. A liquid crystal display device comprising a backlight consisting of LEDs and the backlight control system according to claim 19, wherein the lighting states of the LEDs are controlled by the backlight control system.
